(19) United States
(12) Patent Application Publication
(10) Pub. No.: US 2025/0045182 A1
(43) Pub. Date: Feb. 6, 2025

(54) APPARATUS AND METHOD FOR TRANSFORMING ARTIFICIAL INTELLIGENCE BASED MODEL BASED ON DEVICE AWARENESS

(71) Applicant: NOTA, INC., Daejeon (KR)

(72) Inventors: Shinkook CHOI, Seoul (KR); Dongryeol LEE, Seoul (KR)

(21) Appl. No.: 18/491,294

(22) Filed: Oct. 20, 2023

(30) Foreign Application Priority Data
Aug. 1, 2023 (KR) 10-2023-0100680

(51) Int. Cl. G06F 11/34

(52) U.S. Cl. CPC G06F 11/3428; G06F 11/3447

(57) ABSTRACT

Disclosed is a method for changing an artificial intelligence-based model to suit a target device based on a device awareness, performed by a computing device. The method comprises: obtaining model information corresponding to the artificial intelligence-based model, and target device information indicating a characteristic of the target device on which the artificial intelligence-based model is executed; obtaining a model operator list comprising model operators by determining the model operators included in the artificial intelligence-based model based on the model information, and obtaining a target operator list comprising target operators by determining the target operators which are criteria for changing the model operators, based on the target device information; comparing the model operator list and the target operator list; and changing the artificial intelligence-based model to a target model which is executable at the target device, based on a result of the comparison.

### CROSS-REFERENCE TO RELATED APPLICATIONS

This application claims priority to and the benefit of Korean Patent Application No. 10-2023-0100680 filed in the Korean Intellectual Property Office on Aug. 1, 2023, the entire contents of which are incorporated herein by reference.

### BACKGROUND

### Technical Field

The present disclosure relates to artificial intelligence technology, and more particularly, to transforming an artificial intelligence-based model based on a device-awareness.

### Description of the Related Art

Due to the development of artificial intelligence technology, various types of artificial intelligence based models are being developed. A demand for computational resources to process various AI based models is also increasing, and the development of hardware with new abilities in related industries is continuously developed.

As the demand for edge technology or edge artificial intelligence technology that can perform direct calculations on a network terminal such as personal computers, smart phones, cars, wearable devices, and robots increase, the research and developments of models that take hardware resources into account are made.

As the importance of hardware increases in the field of artificial intelligence technology along with the development of edge technology, sufficient knowledge is required not only about the model itself but also about the various hardware on which artificial intelligence-based models will be executed in order to develop and launch an artificial intelligence-based solution. For example, even if there is a model with excellent performance in a specific domain, inference performance for these models can be different for each hardware where the model is to be executed. There can also be a situation in which a model having optimal performance is not supported in specific hardware in which a service is to be provided in a specific domain. Accordingly, in order to determine the artificial intelligence-based model suitable for the service to be provided and hardware suitable for the artificial intelligence-based model together, high levels of background knowledge and vast amounts of resources for the artificial intelligence technology and hardware technology can be required.

US patent publication No. US2022-0121927 discloses providing a group of neural networks for processing data in a plurality of hardware environments.

### BRIEF SUMMARY

The present disclosure has been made in an effort to efficiently change an artificial intelligence-based model so that the artificial intelligence-based model can be executed at a target device.

However, technical objects of the present disclosure are not restricted to a technical object mentioned above, and other technical objects not mentioned will be able to be apparently appreciated by those skilled in the art.

An exemplary embodiment of the present disclosure provides a method for changing an artificial intelligence-based model to suit a target device based on a device awareness, performed by a computing device. The method can comprise: obtaining model information corresponding to the artificial intelligence-based model, and target device information indicating a characteristic of the target device on which the artificial intelligence-based model is executed; obtaining a model operator list comprising model operators by determining the model operators included in the artificial intelligence-based model based on the model information, and obtaining a target operator list comprising target operators by determining the target operators which are criteria for changing the model operators, based on the target device information; comparing the model operator list and the target operator list; and changing the artificial intelligence-based model to a target model which is executable at the target device, based on a result of the comparison.

In an exemplary embodiment of the present disclosure, the target operator list can comprise operators supportable by the target device.

In an exemplary embodiment of the present disclosure, the obtaining the target operator list can comprise determining the target operators which are criteria for changing at least one of the model operators, based on the target device information and model type information obtained from the model information.

In an exemplary embodiment of the present disclosure, the model information can comprise at least one of a model file corresponding to the artificial intelligence-based model or identification information identifying the artificial intelligence-based model, provided by a user, and

In an exemplary embodiment of the present disclosure, the model operator list can comprise operators constituting the artificial intelligence-based model, obtained by analyzing the model information.

In an exemplary embodiment of the present disclosure, the obtaining the target operator list can comprise: determining whether retraining of the artificial intelligence-based model is available, based on a model type included in the model information; and determining the target operators to be included in the target operator list in different manners depending on whether the retraining of the artificial intelligence-based model is available.

In an exemplary embodiment of the present disclosure, the obtaining the target operator list can comprise: determining whether retraining of the artificial intelligence-based model is available, based on model type included in the model information; and determining the target operators to be compared with the model operators by excluding operators for which training is required from operators supportable by the target device, when it is determined that the retraining of the artificial intelligence-based model is not available

In an exemplary embodiment of the present disclosure, the comparing the model operator list and the target operator list can comprise, determining whether a model operator included in the model operator list matches to at least one of the target operators included in the target operator list, in order from an input operator of the artificial intelligence-based model to an output operator of the artificial intelligence-based model.

In an exemplary embodiment of the present disclosure, the comparing the model operator list and the target operator list can be performed for each of the model operators included in the model operator list.

In an exemplary embodiment of the present disclosure, the changing the artificial intelligence-based model to the target model which is executable at the target device, based on the result of the comparison can comprise, determining not to change a first model operator which matches to a target operator included in the target operator list, among the model operators as the result of the comparison, and determining to change a second model operator which does not match to the target operators included in the target operator list, among the model operators as the result of the comparison.

In an exemplary embodiment of the present disclosure, the changing the artificial intelligence-based model to the target model which is executable at the target device, based on the result of the comparison can comprise, changing a second model operator which does not match to the target operators included in the target operator list, among the model operators, to a replacement operator which is matchable to a target operator included in the target operator list.

In an exemplary embodiment of the present disclosure, the changing the artificial intelligence-based model to the target model which is executable at the target device, based on the result of the comparison can comprise: determining a model operator to be changed within the model operator list, based on the result of the comparison; determining an operator type of the model operator to be changed, based on an operator characteristic corresponding to the model operator to be changed; and changing the model operator to a replacement operator based on the determined operator type.

In an exemplary embodiment of the present disclosure, the operator characteristic can indicate a functional characteristic or an operational characteristic of an operator, and the operator characteristic is assigned to each of the model operators.

In an exemplary embodiment of the present disclosure, the operator type can comprise: a first operator type indicating an activation operation; a second operator type indicating a simple operation having an operation difficulty below a predetermined level; and a third operator type indicating a layer-related operation rather than the simple operation.

In an exemplary embodiment of the present disclosure, the changing the model operator based on the determined operator type can comprise changing the model operator using one change algorithm of: a first change algorithm changing an operator by using similarity decision of an output value to an input value depending on the determined operator type; a second change algorithm changing an operator based on whether mathematical results of operations are matched; or a third change algorithm changing an operator based on similarity of mathematical results of operations.

In an exemplary embodiment of the present disclosure, the changing the model operator based on the determined operator type can comprise: changing the model operator based on a first change algorithm changing an operator by using similarity decision of an output value to an input value, when an operator type of the model operator to be changed is determined as a first operator type indicating an activation operation; changing the model operator based on a second change algorithm changing an operator based on whether mathematical results of operations are matched, when an operator type of the model operator to be changed is determined as a second operator type indicating a simple operation having an operation difficulty below a predetermined level; and changing the model operator based on a third change algorithm changing an operator based on similarity of mathematical results of operations, when an operator type of the model operator to be changed is determined as a third operator type indicating a layer-related operation rather than the simple operation.

In an exemplary embodiment of the present disclosure, the changing the artificial intelligence-based model to the target model which is executable at the target device, based on the result of the comparison can further comprise, determining whether to change the model operator by comparing a user threshold included in a user input with similarity between the model operator and the replacement operator.

In an exemplary embodiment of the present disclosure, the changing the artificial intelligence-based model to the target model which is executable at the target device, based on the result of the comparison further comprises, determining whether to change the model operator based on whether the replacement operator is included in the target operator list.

In an exemplary embodiment of the present disclosure, the method can further comprise: providing a first result indicating a replacement operator to which the change is made in the changed target model, and a second result indicating whether the changed target model is required for retraining.

In an exemplary embodiment of the present disclosure, the method can further comprise: providing a benchmark result obtained by executing the target model to which the artificial intelligence-based model is changed, at the target device.

In an exemplary embodiment of the present disclosure, a computer readable medium storing a computer program is disclosed. For example, the computer readable medium is a non-transitory computer readable medium. The computer program allows a computing device to perform following operations to change an artificial intelligence-based model to suit a target device based on a device awareness when executed by the computing device. The operations can comprise: obtaining model information corresponding to the artificial intelligence-based model, and target device information indicating a characteristic of the target device on which the artificial intelligence-based model is executed; obtaining a model operator list comprising model operators by determining the model operators included in the artificial intelligence-based model based on the model information, and obtaining a target operator list comprising target operators by determining the target operators which are criteria for changing the model operators, based on the target device information; comparing the model operator list and the target operator list; and changing the artificial intelligence-based model to a target model which is executable at the target device, based on a result of the comparison.

In an exemplary embodiment of the present disclosure, a computing device for providing a benchmark result is discloses. The computing device can comprise at least one processor; and a memory. The at least one processor can obtain model information corresponding to the artificial intelligence-based model, and target device information indicating a characteristic of the target device on which the artificial intelligence-based model is executed; obtain a model operator list comprising model operators by determining the model operators included in the artificial intelligence-based model based on the model information, and obtaining a target operator list comprising target operators by determining the target operators which are criteria for changing the model operators, based on the target device information; compare the model operator list and the target operator list; and change the artificial intelligence-based model to a target model which is executable at the target device, based on a result of the comparison.

According to an exemplary embodiment of the present disclosure, a technique can effectively change an artificial intelligence-based model to be executed in a target device in order to enhance a user experience.

### BRIEF DESCRIPTION OF THE SEVERAL VIEWS OF THE DRAWINGS

FIG. 1 schematically illustrates a block diagram of a computing device according to an exemplary embodiment of the present disclosure.

FIG. 2 illustrates an exemplary structure of an artificial intelligence-based model according to an exemplary embodiment of the present disclosure.

FIG. 3 is an exemplary a method for changing an artificial intelligence model to a target model which can be executed at a target device according to an exemplary embodiment of the present disclosure.

FIG. 4 is an exemplary a method for changing an artificial intelligence model to a target model which can be executed at a target device according to an exemplary embodiment of the present disclosure.

FIG. 5 is an exemplary a method for changing an artificial intelligence model to a target model which can be executed at a target device according to an exemplary embodiment of the present disclosure.

FIG. 6 is a schematic view of a computing environment according to an exemplary embodiment of the present disclosure.

### DETAILED DESCRIPTION

Various exemplary embodiments will now be described with reference to drawings. In this specification, various descriptions are presented to provide appreciation of the present disclosure. Prior to describing detailed contents for carrying out the present disclosure, it should be noted that configurations not directly associated with the technical gist of the present disclosure are omitted without departing from the technical gist of the present disclosure. Further, terms or words used in this specification and claims should be interpreted as meanings and concepts which match the technical spirit of the present disclosure based on a principle in which the inventor can define appropriate concepts of the terms in order to describe his/her disclosure by a best method.

“Module,” “system,” and/or “model” which are terms used in the specification refer to a computer-related entity, hardware, firmware, software, and a combination of the software and the hardware, or execution of the software, and can be used interchangeably. For example, the module may be a processing process executed on a processor, the processor, an object, an execution thread, a program, an application, and/or a computing device, but is not limited thereto. One or more modules may reside within the processor and/or a thread of execution. The module may be localized in one computer. One module may be distributed between two or more computers. Further, the modules may be executed by various computer-readable media having various data structures, which are stored therein. The modules may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or.” That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” and “at least one” used in this specification designates and includes all available combinations of one or more items among enumerated related items. For example, the term “at least one of A or B” or “at least one of A and B” should be interpreted to mean “a case including only A,” “a case including only B,” and “a case in which A and B are combined.”

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

Those skilled in the art need to recognize that various exemplary components described in connection with the exemplary embodiments disclosed herein may be additionally implemented as hardware, computer software, or combinations of both sides.

The description of the presented embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure terms represented by N-th such as first, second, or third are used for distinguishing at least one entity. For example, entities expressed as first and second may be the same as each other or different from each other.

The term “model” used in the present disclosure may be used as a meaning that encompasses the artificial intelligence based model, the artificial intelligence model, the computation model, the neural network, a network function, and the neural network. In an exemplary embodiment, the model may mean a model file, identification information of the model, an execution configuration of the model, and a framework of the model.

The term “device” used in the present disclosure may correspond to hardware or hardware identification information in which the model is to be executed. In an additional example, the device may correspond to hardware in which benchmarking of the model is to be performed or hardware identification information. The hardware may be used as a meaning that encompasses physical hardware, virtual hardware, hardware which is impossible to be accessed through the network from the outside, hardware which is impossible to confirm externally, and/or hardware which is confirmed in a cloud. For example, the device in the present disclosure may include various types of hardware such as RaspberryPi, Coral, Jetson-Nano, AVH RasberryPi, and Mobile.

The term “benchmark” used in the present disclosure may mean an operation of executing or testing the model in the device or an operation of measuring the performance for the device of the model. A benchmark result or benchmark result information in the present disclosure may include information obtained according to the benchmark or information obtained by processing the information obtained according to the benchmark. In the present disclosure, a benchmark prediction result or benchmark prediction result information may mean a benchmark result predicted when the model is executed in the device. For example, the benchmark prediction result may correspond to a benchmark result obtained without executing the model in the device (that is, without measuring the performance).

An operator in the present disclosure may be used to mean a component constituting the model. For example, one model may include a plurality of operators. For example, the plurality of operators may be connected to each other through an edge. An operation of the model may be performed through operations of the plurality of operators. For example, the operator may be used interchangeably with a node or layer of the model. As an example, a convolutional layer may become an example for the operator in the artificial intelligence model.

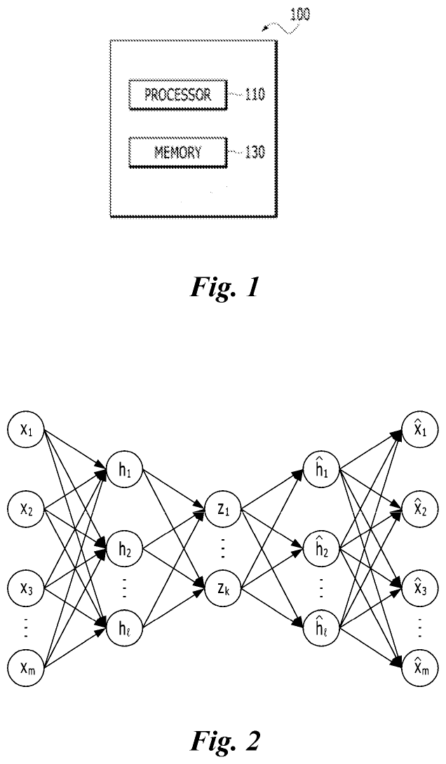

FIG. 1 schematically illustrates a block diagram of a computing device 100 according to an exemplary embodiment of the present disclosure.

According to the exemplary embodiment of the present disclosure, a computing device 100 may include a processor 110 and a memory 130.

A configuration of the computing device 100 illustrated in FIG. 1 is only an example shown through simplification. In an exemplary embodiment of the present disclosure, the computing device 100 may include other components for performing a computing configuration of the computing device 100 and only some of the disclosed components may constitute the computing device 100.

The computing device 100 in the present disclosure may be used as a meaning that encompass any type of server and any type of terminal.

In the present disclosure, the computing device 100 may mean any type of component constituting a system for implementing exemplary embodiments of the present disclosure.

The components of the computing device 100 illustrated in FIG. 1 may be exemplary and some components may be excluded, or an additional component may be included in the computing device 100. As an example, when the computing device 100 includes a user terminal, an output unit (not illustrated) and an input unit (not illustrated) may be included in a scope of the computing device 100.

In an exemplary embodiment, the computing device 100 may mean a device for changing, substituting, transforming, and/or converting a model input based on device awareness to a model suitable for the device.

In an exemplary embodiment, the computing device 100 may mean a device that manages and/or performs the benchmark for a plurality of devices of a specified artificial intelligence-based model in communication with a plurality of devices. For example, the computing device 100 may refer to a device for managing a device farm. In another example, the computing device 100 may also correspond to the device farm.

In an exemplary embodiment, the computing device 100 may mean a device that generates the learning model through modeling for an input dataset, generates a lightweight model through compression for an input model, and/or generates download data so as to deploy the input model in a specific device. For example, the computing device 100 may transform the input model so that the input model is compatible with the specific device.

In the present disclosure, deploy or deployment may mean any type of activity which enables using software (e.g., model). For example, the deploy or deployment may be interpreted as an overall process customized according to specific requirements or characteristics of the model or node. An example for the deploy or deployment may include release, installation and activation, deactivation, removal, update, built-in update, adaptation, and/or version tracking.

In an additional exemplary embodiment of the present disclosure, the computing device 100 may also generate a result of converting the model or obtain the converting result from another computing device or an external entity (e.g. a converting device).

In an exemplary embodiment, the processor 110 may be constituted by at least one core and may include processors for data analysis and/or processing, which include a central processing unit (CPU), a general purpose graphics processing unit (GPGPU), a tensor processing unit (TPU), and the like of the computing device 100.

The processor 110 may read a computer program stored in the memory 130 to provide the benchmark result according to an exemplary embodiment of the present disclosure.

According to an exemplary embodiment of the present disclosure, the processor 110 may also perform a computation for learning a neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of the plurality of computing devices may be used together to process the learning of the network function and the data classification using the network function. Further, the computer program executed in the computing device 100 according to an exemplary embodiment of the present disclosure may be a CPU, GPGPU, or TPU executable program.

Additionally, the processor 110 may generally process an overall operation of the computing device 100. For example, the processor 110 processes data, information, signals, and the like input or output through the components included in the computing device 100 or drives the application program stored in a storage unit to provide information or a function appropriate for the user.

According to an exemplary embodiment of the present disclosure, the memory 130 may store any type of information generated or determined by the processor 110 or any type of information received by the computing device 100. According to an exemplary embodiment of the present disclosure, the memory 130 may be a storage medium that stores computer software which allows the processor 110 to perform the operations according to the exemplary embodiments of the present disclosure. Therefore, the memory 130 may mean computer-readable media for storing software codes required for performing the exemplary embodiments of the present disclosure, data which become execution targets of the codes, and execution results of the codes.

According to an exemplary embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the memory 130 used in the present disclosure is not limited to the examples.

In the present disclosure, the communication unit (not illustrated) may be configured regardless of communication modes such as wired and wireless modes and constituted by various communication networks including a personal area network (PAN), a wide area network (WAN), and the like. Further, the network unit 150 may operate based on known World Wide Web (WWW) and may adopt a wireless transmission technology used for short-distance communication, such as infrared data association (IrDA) or Bluetooth.

The computing device 100 in the present disclosure may include any type of user terminal and/or any type of server. Therefore, the exemplary embodiments of the present disclosure may be performed by the server and/or the user terminal.

In an exemplary embodiment, the user terminal may include any type of terminal which is capable of interacting with the server or another computing device. The user terminal may include, for example, a mobile phone, a smart phone, a laptop computer, personal digital assistants (PDA), a slate PC, a tablet PC, and an ultrabook.

In an exemplary embodiment, the server may include, for example, any type of computing system or computing device such as a microprocessor, a mainframe computer, a digital processor, a portable device, and a device controller.

In an exemplary embodiment, the server may store and manage a target operator list, a model operator list, a benchmark result, a benchmark prediction result, and/or performance information of devices. For example, the server may include a storage unit (not illustrated) for storing the information. The storage unit may be included in the server, or may be present under the management of the server. As another example, the storage unit may also be present outside the server, and implemented in a form which is capable of communicating with the server. In this case, the storage unit may be managed and controlled by another external server different from the server. As another example, the storage unit may also be present outside the server, and implemented in a form which is capable of communicating with the server. In this case, the storage unit may be managed and controlled by another external server different from the server.

FIG. 2 illustrates an illustrative structure of an artificial intelligence based model according to an exemplary embodiment of the present disclosure.

Throughout the present disclosure, the model, the artificial intelligence model, the artificial intelligence based model, the operation model, and the neural network, the network function, and the neural network may be used interchangeably.

The artificial intelligence based model in the present disclosure may include models which are utilizable in various domains, such as a model for image processing such as object segmentation, object detection, and/or object classification, a model for text processing such as data prediction, text semantic inference and/or data classification, etc.

The neural network may be generally constituted by an aggregate of calculation units which are mutually connected to each other, which may be called “node.” The nodes may also be called neurons. The neural network is configured to include one or more nodes. The nodes (or neurons) constituting the neural networks may be mutually connected to each other by one or more links.

The node in the artificial intelligence based model may be used to mean a component that constitutes the neural network, and for example, the node in the neural network may correspond to the neuron.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an exemplary embodiment of the present disclosure, the set of the neurons or the nodes may be defined as the expression “layer.”

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. That is, photographs, text, video, voice, protein sequence structure, genetic sequence structure, peptide sequence structure, and/or potential structure of music (e.g., what objects are in the photo, what is the content and emotions of the text, what contents and emotions of the voice, etc.). The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in a clustering model in the present disclosure may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an exemplary embodiment of the present disclosure, a computer readable medium is disclosed, which stores a data structure including the benchmark result and/or the artificial intelligence based model. The data structure may be stored in a storage unit (not illustrated) in the present disclosure, and executed by the processor 110 and transmitted and received by a communication unit (not illustrated).

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node.” The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

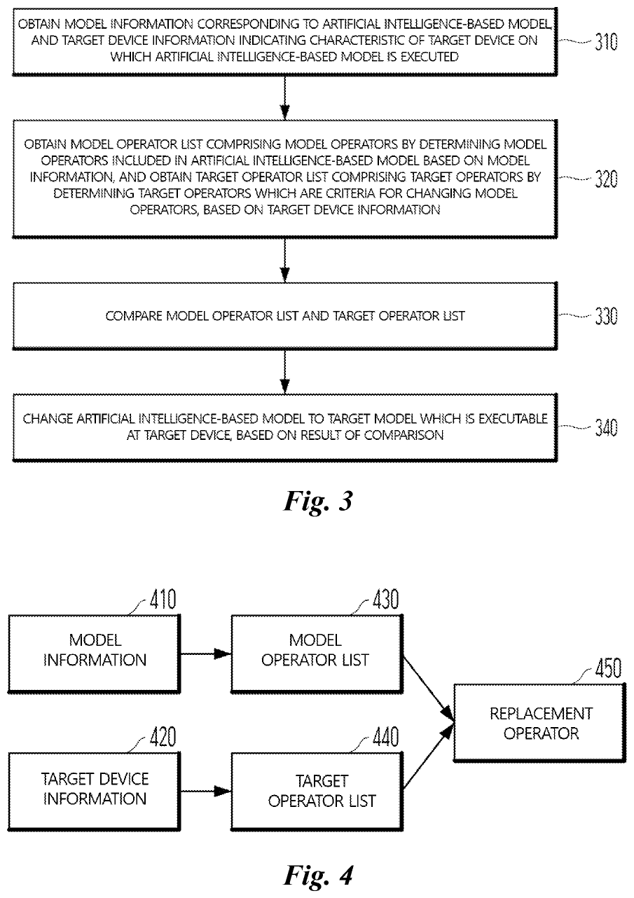

FIG. 3 exemplarily illustrates a method for changing an artificial intelligence-based model to a target model which can be executed at a target device according to an exemplary embodiment of the present disclosure.

As illustrated in FIG. 3, the computing device 100 may obtain model information corresponding to the artificial intelligence-based model, and target device information indicating a characteristic of a target device on which the artificial intelligence-based model is executed (S310).

In an exemplary embodiment, the model information corresponding to the artificial intelligence-based model may include any type of information identifying the artificial intelligence-based model. For example, the model information may include identification information of an artificial intelligence model and/or model file information corresponding to the artificial intelligence-based model. For example, the model information may be obtained by an input from a user. For example, the input from the user may include a selection input of selecting a specific model identifier and/or an upload input of uploading a model file among a plurality of selections. In an additional example, the model information may include identification information of a model, a name of a model file, an extension of the model file, the model file itself, a software version, a framework, a size of the model, an input shape of the model, a batch size, and/or the number of channels.

In an exemplary embodiment, the computing device 100 may obtain the model information input from the user and target device information input from the user. For example, the target device information may include any type of information for identifying a device on which an artificial intelligence-based model corresponding to the model information input from the user is executed. For example, the target device information may include identification information of a target device, information for describing a characteristic (e.g., a memory capacity, processor information, and/or performance information) of the target device, and/or manufacturer information of the target device. As a non-limiting example, the target device information may include Jetson Nano, Jetson Xavier NX, Jetson TX2, Jetson AGX Xavier, Jetson AGX Orin, GPU AWS-T4, Xcon-W-2223, Raspberry Pi Zero, Raspberry Pi 2W, Raspberry Pi 3B+, and/or Raspberry Pi Zero 4B.

In the present disclosure, the target device may be used to refer to the device on which the artificial intelligence-based model is executed. For example, the target device may correspond to an embedded device on which the artificial intelligence-based model is executed. For example, the target device may be determined by a user input.

In an exemplary embodiment, the computing device 100 determines model operators included in the artificial intelligence-based model based on the model information to obtain a model operator list including the model operators, and determines target operators which become criteria to change the model operators based on the target device information to obtain a target operator list including target operators (320).

In an exemplary embodiment, the model operator may correspond to an operator constituting the artificial intelligence-based model. For example, the model operator may be obtained based on the model information determined from the user input. For example, the model operators may include operators prestored to correspond to the model information. For example, the model operators may be obtained based on parsing the model file. For example, it is assumed that the model is constituted by a first operator that performs a first convolutional operation, a second operator that performs a sigmoid operation, a third operator that performs a second convolutional operation, and a fourth operator that performs an Add operation. The computing device 100 may obtain model operators corresponding to the first operator, the second operator, the third operator, and the fourth operator from the input model, through parsing for the model. In an exemplary embodiment, the model operator list may correspond to a group of the model operators.

In an exemplary embodiment, the target operator may correspond to an operator which is supportable at the target device or an operator which is compatible at the target device. For example, the target operator may be prestored to correspond to the target device. For example, the target operator may become a criterion for determining whether the model operator should be changed. The target operator list may correspond to a group of the target operators.

In an exemplary embodiment, the computing device 100 may determine model type information from the input model information. For example, the model type information may include an extension of the model file. In such an example, the computing device 100 may determine whether the corresponding model is a model which can be retrained based on the extension of the model file included in the model information. For example, a model corresponding to an extension ONNX and/or an extension PT may be predetermined as a model that can be retrained. For example, a model corresponding to an extension TFLITE may be predetermined as a model that cannot be retrained. For example, when the artificial intelligence-based model is transformed to operate to be suitable for the target device, even though the artificial intelligence-based model is a pretrained model, it may be necessary to retrain the converted model. A technique according to an exemplary embodiment of the present disclosure may distinguishingly manage the type of model for which retraining is available and the type of model for which retraining is not available, and an operator in the model which needs to be retrained and an operator in the model which need not be retrained are distinguished to transform the artificial intelligence-based model to be suitable for the target device.

In an exemplary embodiment, the computing device 100 may determine whether the retraining of the artificial intelligence-based model is available based on the model type included in the model information, and determine the target operators to be included in the target operator list in different manners according to whether retraining of the artificial intelligence-based model is available. For example, when it is determined that the retaining of the model is available according to the extension of the model, the computing device 100 may include operators corresponding to a first type in the target operator list. For example, when it is determined that the retaining of the model is not available according to the extension of the model, the computing device 100 may include operators corresponding to a second type in the target operator list.

In an exemplary embodiment, the computing device 100 may determine target operators which become criteria for changing at least one of the model operators based on the model type information and the target device information. For example, the computing device 100 may determine the target operators based on whether retraining is performed determined according to the model type information among the operators corresponding to the target device information. Operators which are supported by a specific target device may be classified into an operator for which retraining is required and an operator for which retraining is not required. For example, the ADD operator may be classified into the operator for which retraining is not required, and the Convolutional operator may be classified into an operator for which retraining is required.

In an exemplary embodiment, the computing device 100 may determine the target operator list corresponding to the target device information by considering both retraining characteristics of the operators supported by the target device and retraining characteristics of the model according to the extension of the model file. For example, the computing device 100 may exclude operators (e.g., dense layer and/or convolutional layer) for which training is required upon configuring the target operator list when the input model information includes the extension for which retraining is not available.

In an exemplary embodiment, the computing device 100 may compare the model operator list and the target operator list (330).

In an exemplary embodiment, the computing device 100 may determine whether the model operator included in the model operator list matches to at least one of the target operators included in the target operator list according to an order from an input operator of the artificial intelligence-based model to an output operator. The comparison between the model operator list and the target operator list may be performed with respect to each of the model operators included in the model operator list.

For example, the computing device 100 may determine the order of the model operators in the model operator list corresponding to the artificial intelligence-based model. The order of the model operators may correspond to a time-series order of operations of the artificial intelligence-based models, which corresponds thereto. For example, it is assumed that the artificial intelligence-based model includes a first layer that receives an image as an input, and performs a convolutional operation, a second layer that receives an output of the first layer as the input, and performs the sigmoid operation, and a third layer that performs an addition or multiplication operation by inputting the output of the first layer and the output of the second layer. In such a situation, the computing device 100 may determine an operating order of the artificial intelligence-based model as an order of the first layer, the second layer, and the third layer. The computing device 100 may perform comparison of respective operators included in the artificial intelligence-based model with the target operator list in an order from the input operator of the artificial intelligence-based model to the output operator.

In an exemplary embodiment, the computing device 100 may compare the model operator list and the target operator list by a manner of determining whether operators corresponding to the model operators included in the model operator list, respectively are included in the target operator list. For example, when there is an operator which corresponding to a first model operator included in the model operator list in the target operator list, the computing device 100 may determine that the first model operator matches to the target operator list. For example, when there is no operator which is the same as a second model operator included in the model operator list in the target operator list, but there is an operator which substantially functionally corresponds to the second model operator in the target operator list, the computing device 100 may determine that the second model operator matches to the target operator list.

In an exemplary embodiment, when it is determined that the model operator matches to the target operator which exists in the target operator list, the computing device 100 may determine to use the model operator as it is without changing the model operator. Since the target operator is the operator which is supportable by the target device on which the model is executed, when the model operator matches to the target operator, a next model operator may be compared with the target operator list without changing the model operator.

In an exemplary embodiment, when the model operator does not match to the target operator which exists in the target operator list, the computing device 100 may determine that the model operator needs to be changed to a replacement operator. When the model operator does not match to the target operator which exists in the target operator list according to a result of the comparison, the computing device 100 changes the model operator to the replacement operator to change the artificial intelligence-based model to a target model which can be executed at the target device.

In an exemplary embodiment, the computing device 100 may change the artificial intelligence-based model to a target model which is executable at the target device based on the result of the comparison (340).

In an exemplary embodiment, the computing device 100 may determine not to change, for a first model operator which matches to the target operator included in the target operator list among the model operator, the first model operator according to a result of comparison between the model operator list and the target operator list. The computing device 100 may determine to change, for a second model operator which does not match to the target operator included in the target operator list among the model operator, the second model operator according to the result of the comparison.

In an exemplary embodiment, the computing device 100 may determine to change the second model operator which does not match to the target operator included in the target operator list among the model operator to a replacement operator which is matchable to the target operator included in the target operator list. The operator may be referred to as the replacement operator so that the model operator corresponds to the target operator. For example, the replacement operator is not the same as the model operator, but may refer to an operator which may similarly perform a function performed by the model operator. For example, the replacement operator may also refer to the same operator as the target operator included in the target operator list. The computing device 100 changes the model operator to the replacement operator, so the artificial intelligence-based model may be changed to the target model which is executable at the target device. The target model may correspond to a model in which at least some of the model operators included in the artificial intelligence-based model are changed so that the artificial intelligence-based model is executable at the target device.

In an exemplary embodiment, the computing device 100 may determine a model operator to be changed in the model operator list based on the result of the comparison, and determine an operator type of the model operator to be changed based on an operator characteristic corresponding to the model operator to be changed. The computing device 100 may change the model operator to the replacement operator based on the determined operator type. For example, the computing device 100 may change the model operator to the replacement operator in different manners according to the operator type of the model operator to be changed.

In an exemplary embodiment, an operator characteristic may refer to an operational characteristic or a functional characteristic of the operator. Such an operator characteristic may be allocated to each of the model operators. For example, a first operator type may be allocated to a first model operator included in the model operator list, a second operator type may be allocated to a second model operator, a third operator type may be allocated to a third model operator, and the first operator type may be allocated to a fourth model operator.

In an exemplary embodiment, the operator characteristic or the operator type may have a plurality of predetermined types. The operator characteristic or the operator type may be classified into an operational unit performed by the operator or a functional unit of the operator. For example, the operator characteristic or the operator type may include a first operator type indicating an activation operation, a second operator type indicating a simple operation having an operation difficulty below a predetermined level, and a third operator type indicating a layer-related operation other than the simple operation.

In an exemplary embodiment, the first operator type may be allocated to an operator that performs the activation operation. For example, the activation operation may include a Sigmoid related operation, Tanh related operation, a ReLU related operation, an ELU related operation, and/or a Maxout operation.

In an exemplary embodiment, the second operator type may be allocated to an operator that performs a simple operation having a low difficulty (e.g., a difficulty below a predetermined threshold difficulty). For example, the simple operation may include an addition operation, a multiplication operation, and/or a subtraction operation.

In an exemplary embodiment, the third operator type may be allocated to an operator that performs the layer-related operation other than the simple operation. For example, the layer-related operation may include the convolutional operation.

In an exemplary embodiment, the computing device 100 may differently perform an operator change scheme according to the operator characteristic or the operator type corresponding to the model operator to be changed. The computing device 100 may include a plurality of different operator change algorithms. For example, the plurality of different operator change algorithms may include a first change algorithm changing an operator by using similarity decision of an output value to an input value, a second change algorithm changing an operator based on whether mathematical results of operations are matched, and/or a third change algorithm changing an operator based on similarity of mathematical results of operations. For example, the operator change algorithm may include an algorithm for changing the model operator to correspond to the target operator or to have a similar function to the target operator.

In an exemplary embodiment, the computing device 100 may change the model operator to the replacement operator by using the operator change algorithm corresponding to the operator type. For example, when the operator types of the model operators to be changed are different, the operator change algorithm used for changing the model operator may be different.

In an exemplary embodiment, when the operator type of the model operator to be changed is determined as the first operator type indicating the activation operation, the computing device 100 may change the model operator to the replacement operator based on the first change algorithm changing the operator by using the similarity decision of the output value to the input value. For example, the first change algorithm may perform operator change by using the similarity of the activation operation. The first change algorithm may perform the operator change by using a similarity of the value between an input of the operator and an activation output, a similarity of the input, or a similarity of the activation output. For example, the first change algorithm may determine a target operator (or a target operator having a highest similarity) having a similarity to an activation value of the model operator to be changed, which is equal to or more than a predetermined threshold as a target (e.g., the replacement operator) of the change. When the model operator to be changed is determined as the first operator type, the computing device 100 may determine, based on the first change algorithm, the replacement operator which becomes the target of the change of the model operator to be changed among a plurality of target operators.

$$similarity = \frac{{Y}_{v} \cdot {\hat{Y}}_{v}}{\vert {Y}_{v} \vert \vert {\hat{Y}}_{v} \vert} , \qquad Equation 1$$

$${Y}_{v} = [ {Y}_{z = 0} , … , {Y}_{z = 5} ] ,$$

$${\hat{Y}}_{v} = [ {\hat{Y}}_{z = 0} , … , {\hat{Y}}_{z = 6} ]$$

In an exemplary embodiment, when an input value X (for example, X={x|−6≤x≤6}) is an integer, a model operator is Y (for example, Y={y|y=Model_operator(x)}), and the target operator is Ŷ (for example, Ŷ={y|y=Target_operator(x)}), similarity decision according to the first change algorithm may be conducted according to contents illustrated in Equation 1 above. As an example, v in Equation 1 may correspond to a natural number. For example, the first change algorithm may use for each of values input into the operator for the similarity decision. For example, the first change algorithm may determine the replacement operator which becomes the target change of the model operator among the plurality of target operators by a scheme of comparing similarities between the model operator (for example, Y) and the respective target operators (for example, Ŷ) included in the target operator list.

In an exemplary embodiment, when the operator type of the model operator to be changed is determined as the second operator type indicating the simple operation having an operation difficulty below the predetermined level, the model operator may be changed to the replacement operator based on the second change algorithm changing the operator based on whether the mathematical results of the operations are matched.

In an exemplary embodiment, the second change algorithm may include an algorithm for changing the model operator to a mathematically or formula corresponding operator. For example, the second change algorithm may include an algorithm for finding the mathematical or formula corresponding or most similar operator in the target operator list. For example, when the model operator to be changed is a Pow operator that performs a power, the computing device 100 may change the model operator to a form of using a plurality of (for example, two) Mul operators that perform the multiplication operation included in the target operator list. In an additional example, the change of the model operator may be performed additionally based on the user input. For example, if there is an operator designated not to be used by the user, the computing device 100 may perform the operator change based on a target operator other than an operator designated by the user in the target operator list.

In an exemplary embodiment, when the operator type of the model operator to be changed is determined as the third operator type indicating the layer-related operation other than the simple operation, the computing device 100 may change the model operator to the replacement operator based on the third change algorithm changing the operator based on the similarity of the mathematical results of the operations. In an exemplary embodiment, when the model operator to be changed is determined as the layer-related operator type, the model operator may be changed to an operator that achieves a functionally or mathematically most similar result. For example, in the case of a model operator using a filter in which kernel_size of a convolution layer=6, a first target operator utilizing two convolution layers using a filter in which kernel_size=3 and a second target operator using one convolution layer using a filter in which kernel_size=7 may be considered. When values of one row and one column of the filter in which kernel_size=7 are changed to 0, a result thereof may be formularly matched to an original convolution layer. Accordingly, the computing device 100 may determine to change the model operator to a replacement operator using one convolution layer using the filter in which kernel_size=7 in such an example. In an additional example, the change of the model operator may be performed additionally based on the user input. An element which a weight according to the user input may be attached may include the number of layers, kernel_size, strides, and/or pad. For example, when it is determined that a convolution layer having a relatively small kernel_size is selected as the replacement operator according to a priority determined according to the user input, the computing device 100 may determine the first target operator utilizing two convolution layers in which kernel_size=3 among the first target operator and the second target operator as the change target.

In an exemplary embodiment, the computing device 100 compares the similarity between the replacement operator which becomes the target of the change and the model operator to be changed, and a user threshold or user restraint included in the user input to determine whether to change the model operator. The user threshold or user restraint included in the user input may include a threshold for the similarity, a threshold for the number of specific elements, user preference information indicating that a specific operator is intended to be used, and/or user designation information indicating that the specific operator is not used. In an exemplary embodiment, the computing device 100 may determine whether to change the model operator to the replacement operator by comparing the user threshold or user restraint according to the user input with the replacement operator to which the model operator is to be changed.

In an exemplary embodiment, the computing device 100 may determine whether to change the model operator based on whether the replacement operator to which the model operator is to be changed is included in the target operator list. When the replacement operator to which the model operator is to be changed is not included in the target operator list, it may be determined that the change for the model operator is not performed.

FIG. 4 exemplarily illustrates a method for changing an artificial intelligence-based model to a target model which can be executed at a target device according to an exemplary embodiment of the present disclosure.

In an exemplary embodiment, the computing device 100 may obtain model information 410 and target device information 420. In an exemplary embodiment, the computing device 100 may receive a user input including a user threshold or user restraint jointly with the model information 410 and the target device information 420.

In an exemplary embodiment, the computing device 100 may obtain or generate a model operator list 430 from the model information 410. In an exemplary embodiment, the computing device 100 may obtain or generate a target operator list from the target device information 420.

In an exemplary embodiment, the computing device 100 analyzes the model information to determine identification information of operators included in a model and/or order information of the operators. For example, the model information as any type of information for identifying the model may include information indicating an execution configuration of the model, such as Tflite, Onnxruntime, OpenVINO, and Tensorrt. For example, the model information may also include library information or software version information for the execution configuration of the model. In such an example, the model information may be expressed as Python 3.7.3 and pillow 5.4.1 of Tflite. For example, the model information may include a model file. In this case, the computing device 100 analyzes the model file to obtain identification information of operators which operate in the model file.

In an exemplary embodiment, the computing device 100 may obtain a target operator list mapped to the target device information and including pre-stored target operators. For example, the target device information may include any type of information identifying a target device. As a non-limiting example, the target device may include various types of hardware such as Jetson Nano, Jetson Xavier NX, Jetson TX2, Jetson AGX Xavier, Jetson AGX Orin, GPU AWS-T4, Xcon-W-2223, Raspberry Pi Zero, Raspberry Pi 2W, Raspberry Pi 3B+, Raspberry Pi Zero 4B, and Mobile.

In an additional exemplary embodiment, the computing device 100 may also include target device information including a performance of a target device designated by a user. In such an exemplary embodiment, the target device information may include performance information of a device on which the model is to be executed. As a result, the computing device 100 may provide a candidate target device list including target devices satisfying the performance information based on the performance information. In response to a user input of selecting the target device on the candidate target device list, the computing device 100 may obtain a (pre-stored) target operator list corresponding to the selected target device. For example, an example for the performance information may include latency information, power consumption information, and/or memory usage information.

In an exemplary embodiment, the computing device 100 compares the model operator list 430 and the target operator list 440 to change the model operator to a replacement operator 450. The replacement operator 450 may be determined by a different manner according to the operator type corresponding to the model operator. The replacement operator 450 may correspond to at least one of target operators included in the target operator list 440.

In an exemplary embodiment, the computing device 100 may transform the model of the user to be executable at the target device in response to reception of the model information 410 and the target device information 420. By such a manner, the technique according to an exemplary embodiment of the present disclosure may provide, to the user, a model which is executable in a device based on device awareness or hardware awareness.

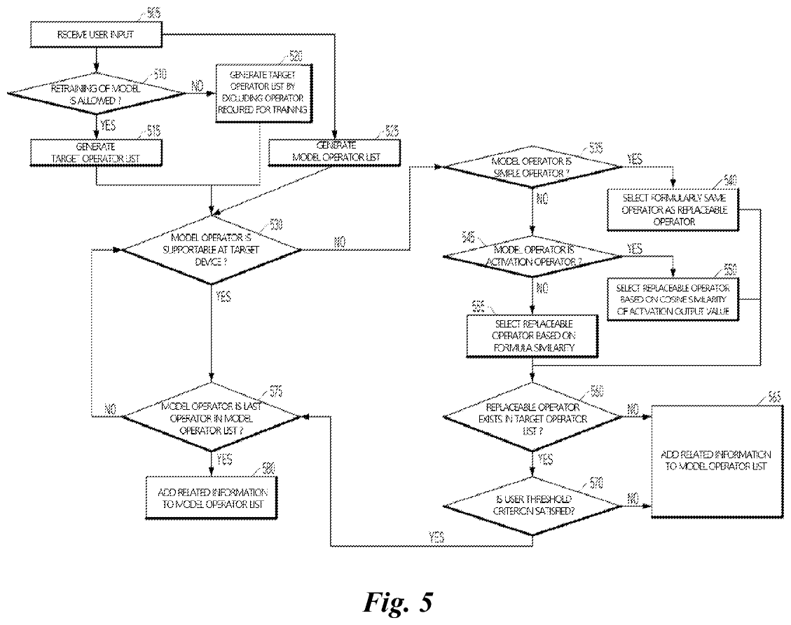

FIG. 5 exemplary illustrates a method for changing an artificial intelligence-based model to a target model which can be executed at a target device according to an exemplary embodiment of the present disclosure.

A technique according to an exemplary embodiment of the present disclosure may provide whether the corresponding model is executable in an embedded device to the user, whether retraining of the corresponding model is required, and/or an executable model or an execution impossible reason based on model information to be executed in the embedded target device provided by the user, and a maximum similarity between a target device non-support operator and a target device support operator, and a weight required for similarity decision.

In an exemplary embodiment, the computing device 100 may receive a user input for changing the artificial intelligence-based model to a target model which is executable at the target device (505). For example, the user input may include model information corresponding to the artificial intelligence-based model, target device information corresponding to a target device on which the model is executed, and/or user information related to a user restraint, a user weight, or a user threshold related to a model to be changed.

In an exemplary embodiment, the computing device 100 may determine whether the artificial intelligence-based model is a model which can be retrained based on the user input (510). For example, the computing device 100 may determine whether the artificial intelligence-based model is the model which can be retrained based on model information included in the user input. For example, the computing device 100 may determine whether the artificial intelligence-based model is the model which can be retrained based on a model file of the artificial intelligence-based model included in the user information. For example, the computing device 100 may determine whether the artificial intelligence-based model is the model which can be retrained by using a model extension of the model file. For example, the computing device 100 may determine whether the artificial intelligence-based model is the model which can be retrained by using pre-stored data mapping the model extension and whether the artificial intelligence-based model can be retrained. The pre-stored data may include data representing whether the extension can be retrained for each extension of the model.

In an exemplary embodiment, the computing device 100 may generate a target operator list when the artificial intelligence-based model included in the model information is the model which can be retrained (515). In an exemplary embodiment, the target operator list may correspond to a set of target operators which are supportable in a target device included in the user input.

In an exemplary embodiment, the computing device 100 may generate a target operator list not including an operator which needs to be trained when the artificial intelligence-based model included in the model information is a model which cannot be retrained (520). For example, the computing device 100 may pre-allocate whether training is required for each operator. The computing device 100 determines whether the model can be retrained by using the model extension of the model information, and when the corresponding model is the model which can be retrained, excludes an operator which needs to be trained among the operators which are supportable at the target device (that is, includes only an operator which need not be trained) to generate the target operator list.

In an exemplary embodiment, the computing device 100 may determine whether the model can be retrained according to the model extension included in the model information, and vary target operators to be included in the target operator list according to whether the model can be retrained.

In an exemplary embodiment, the computing device 100 may generate a model operator list in response to reception of the user input (525). The model operator list which is a set of model operators included in the model may be generated based on the model information included in the user input.

In an exemplary embodiment, the computing device 100 compares the target operator list and the model operator list to determine whether each of the model operators included in the model operator list is an operator which is supportable at the target device (530). In an exemplary embodiment, when it is determined that the model operator is included in the target operator list, the computing device 100 may determine that the change is not applied to the model operator and perform comparison for a next model operator. In an exemplary embodiment, when it is determined that the model operator is not included in the target operator list, the computing device 100 may determine that the model operator needs to be changed to correspond to the target operator.

In an exemplary embodiment, when it is determined that the model operator needs to be changed, the computing device 100 may determine whether to change the model operator and/or a model operator change scheme based on an operator type of the model operator.

In an exemplary embodiment, the computing device 100 may determine whether the model operator corresponds to a simple operator (535). The computing device 100 may determine whether an operator type pre-allocated to the model operator corresponds to a simple operator type having a mathematical difficulty below a predetermined threshold difficulty.

In an exemplary embodiment, when it is determined that the model operator corresponds to the simple operator, the computing device 100 may select an operator which outputs the formularly same operation result as the model operator as the replacement operator (540). For example, the formularly same operation result may include an operation result according to a combination of an addition operation, a multiplication operation, a division operation, a power operation, and/or a subtraction operation.

In an exemplary embodiment, when it is determined that the model operator does not correspond to the simple operator, the computing device 100 may determine whether the model operator corresponds to an activation operator (545). For example, the activation operator may perform a function of converting a total of input signals into an output signal. For example, the activation operator may be used for determining whether the total of the input signals causes activation. For example, the activation operator may be operated by using a non-linear function.

In an exemplary embodiment, when it is determined that the model operator corresponds to the activation operator, the computing device 100 may select a replaceable operator based on a cosine similarity of an activation output value (550). For example, the computing device 100 may determine a change target of the model operator by using a similarity between an activation output value of the model operator and an activation output value of the target operator. For example, the computing device 100 may determine the target operator which becomes the change target of the model operator among candidate target operators based on similarities (e.g., cosine similarity) between the activation output value of the model operator and activation output values of respective candidate target operators. For example, the computing device 100 may select an activation operator having a highest similarity among the candidate target operators. When a similarity threshold exists in the user input, the computing device 100 may set an activation operator having a highest similarity among activation operators having a similarity larger than the threshold as a target which is to replace the model operator.

In an exemplary embodiment, when it is determined that the model operator is not the activation operator (for example, when the model operator is neither the simple operator nor the activation operator), the computing device 100 may determine that the model operator corresponds to a layer-related operator.

In an exemplary embodiment, when it is determined that the model operator corresponds to the layer-related operator, the computing device 100 may select the operator which is to replace the model operator based on a formula similarity of an operation or operation result of the operator (555). For example, the formula similarity may include a similarity of output results according to the operator. For example, the formula similarity may be used for finding an operator having a most similar output result of the operator. For example, the formula similarity may be determined based on the kernel size, the pad, the stride, and/or the number of layers.

In an exemplary embodiment, the computing device 100 may determine whether the replaceable operator determined in steps 540, 550, and/or 555 exists in the target operator list (560).

In an exemplary embodiment, when the replaceable operator does not exist in the target operator list, the computing device 100 may store and update information representing contents that there is no operator which is to replace the model operator in relation to the model operator list (565). For example, information related to an operator replacement failure may include information related to a case where the replaceable operator included in the user input does not confirm to a user requirement and/or a case where there is no operator which is to replace the operator in the target operator list.

In an exemplary embodiment, when there is the replaceable operator in the target operator list, the computing device 100 may determine whether the replaceable operator satisfies a user threshold criterion included in the user input (570). When it is determined that the replaceable operator does not satisfy the user threshold criterion, the computing device 100 may store and update information representing contents that there is no operator which is to replace the model operator in relation to the model operator list (565). When it is determined that the replaceable operator satisfies the user threshold criterion, the computing device 100 may determine to change the model operator to the replacement operator, and add related information to the model operator list (580).

In an exemplary embodiment, the computing device 100 may perform a methodology illustrated in FIG. 5 for each of the model operators included in the model operator list. As a result, the computing device 100 may determine whether a model operator which becomes a current processing target is a last operator in the model operator list (575). When it is determined that the corresponding model operator is the last operator (e.g., an output layer), the computing device 100 may add the related information to the model operator list, and when it is determined that the corresponding model operator is not the last operator, the computing device 100 returns to step 530 to determine whether a next model operator is the operator which is supportable at the target device.

In an exemplary embodiment of the present disclosure, the computing device 100 may provide, to the user, at least one of first information indicating whether the artificial intelligence-based model can operate at the target device, second information indicating whether the artificial intelligence-based model can be retrained, third information on the target model to which the artificial intelligence-based model is changed, and/or fourth information including benchmark information for the target model.

The technique according to an exemplary embodiment of the present disclosure may automatically convert the operator of the artificial intelligence-based model for supporting the target device based on device awareness. The technique according to an exemplary embodiment of the present disclosure may substitute operators of the model which are not supported at the target device into operators having a most similar function according to the user requirement based on the device awareness. In an exemplary embodiment, the user may receive a transformed model which is most similar to a designed model and operates at a specific target device only by providing model information and target device information to be executed. Since the technique according to an exemplary embodiment of the present disclosure may provide, to the user, information on operators to be changed, information on operators which are not supported at the target device and information such as whether the model can be retrained, the user may receive operators of the artificial intelligence-based model which confirm to a user request and operate at a target embedded device by a resource efficient scheme. As a result, a burden that operators which are not supported by a specific embedded device should be redesigned to operators supported by the device may be removed.

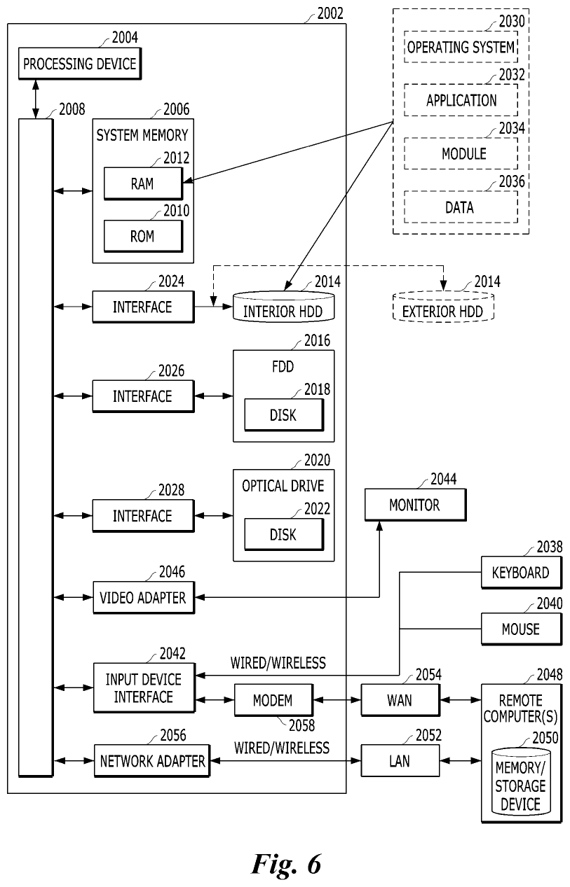

FIG. 6 is a schematic view of a computing environment of the computing device 100 according to an exemplary embodiment of the present disclosure.

In the present disclosure, the computing device, the computer, the system, the component, the module, or the unit includes a routine, a procedure, a program, a component, and a data structure that perform a specific task or implement a specific abstract data type. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computing device, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2002 is shown and the computer 2002 includes a processing device 2004, a system memory 2006, and a system bus 2008. The computer 200 in the present disclosure may be used intercompatibly with the computer device 100. The system bus 2008 connects system components including the system memory 2006 (not limited thereto) to the processing device 2004. The processing device 2004 may be a predetermined processor among various commercial processors. A dual processor and other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (for example, EIDE and SATA), a magnetic floppy disk drive (FDD) 2016 (for example, for reading from or writing in a mobile diskette 2018), SSD and an optical disk drive 2020 (for example, for reading a CD-ROM disk 2022 or reading from or writing in other high-capacity optical media such as the DVD). The hard disk drive 2014, the magnetic disk drive 2016, and the optical disk drive 2020 may be connected to the system bus 2008 by a hard disk drive interface 2024, a magnetic disk drive interface 2026, and an optical drive interface 2028, respectively. An interface 2024 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 2002, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached in the RAM 2012. It will be well appreciated that the present disclosure may be implemented in operating systems which are commercially usable or a combination of the operating systems.

A user may input instructions and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058, is connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that an illustrated network connection is exemplary and other means configuring a communication link among computers may be used.

The computer 2002 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for changing an artificial intelligence-based model to suit a target device based on a device awareness, performed by a computing device, comprising:
obtaining model information corresponding to the artificial intelligence-based model, and target device information indicating a characteristic of the target device on which the artificial intelligence-based model is executed;
obtaining a model operator list comprising model operators by determining the model operators included in the artificial intelligence-based model based on the model information, and obtaining a target operator list comprising target operators by determining the target operators which are criteria for changing the model operators, based on the target device information;
comparing the model operator list and the target operator list; and
changing the artificial intelligence-based model to a target model which is executable at the target device, based on a result of the comparison.

2. The method of claim 1, wherein the target operator list comprises operators supportable by the target device.

3. The method of claim 1, wherein the obtaining the target operator list comprises determining the target operators which are criteria for changing at least one of the model operators, based on the target device information and model type information obtained from the model information.

4. The method of claim 1, wherein the model information comprises at least one of a model file corresponding to the artificial intelligence-based model or identification information identifying the artificial intelligence-based model, provided by a user, and
wherein the model operator list comprises operators constituting the artificial intelligence-based model, obtained by analyzing the model information.

5. The method of claim 1, wherein the obtaining the target operator list comprises:
determining whether retraining of the artificial intelligence-based model is available, based on a model type included in the model information; and
determining the target operators to be included in the target operator list in different manners depending on whether the retraining of the artificial intelligence-based model is available.

6. The method of claim 1, wherein the obtaining the target operator list comprises:
determining whether retraining of the artificial intelligence-based model is available, based on model type information included in the model information; and
determining the target operators to be compared with the model operators by excluding operators for which training is required from operators supportable by the target device, when it is determined that the retraining of the artificial intelligence-based model is not available.

7. The method of claim 1, wherein the comparing the model operator list and the target operator list comprises,
determining whether a model operator included in the model operator list matches to at least one of the target operators included in the target operator list, in order from an input operator of the artificial intelligence-based model to an output operator of the artificial intelligence-based model.

8. The method of claim 7, wherein the comparing the model operator list and the target operator list is performed for each of the model operators included in the model operator list.

9. The method of claim 1, wherein the changing the artificial intelligence-based model to the target model which is executable at the target device, based on the result of the comparison comprises,
determining not to change a first model operator which matches to a target operator included in the target operator list, among the model operators as the result of the comparison, and determining to change a second model operator which does not match to the target operators included in the target operator list, among the model operators as the result of the comparison.

10. The method of claim 1, wherein the changing the artificial intelligence-based model to the target model which is executable at the target device, based on the result of the comparison comprises,
changing a second model operator which does not match to the target operators included in the target operator list, among the model operators to a replacement operator which is matchable to a target operator included in the target operator list.

11. The method of claim 1, wherein the changing the artificial intelligence-based model to the target model which is executable at the target device, based on the result of the comparison comprises:
determining a model operator to be changed within the model operator list, based on the result of the comparison;
determining an operator type of the model operator to be changed, based on an operator characteristic corresponding to the model operator to be changed; and
changing the model operator to a replacement operator based on the determined operator type.

12. The method of claim 11, wherein the operator characteristic indicates a functional characteristic or an operational characteristic of an operator, and the operator characteristic is assigned to each of the model operators, and
wherein the operator type comprises:
a first operator type indicating an activation operation;
a second operator type indicating a simple operation having an operation difficulty below a predetermined level; and
a third operator type indicating a layer-related operation rather than the simple operation.

13. The method of claim 11, wherein the changing the model operator based on the determined operator type comprises changing the model operator using one change algorithm of:
a first change algorithm changing an operator by using similarity decision of an output value to an input value depending on the determined operator type;
a second change algorithm changing an operator based on whether mathematical results of operations are matched; or
a third change algorithm changing an operator based on similarity of mathematical results of operations.

14. The method of claim 11, wherein the changing the model operator based on the determined operator type comprises:
changing the model operator based on a first change algorithm changing an operator by using similarity decision of an output value to an input value, when an operator type of the model operator to be changed is determined as a first operator type indicating an activation operation;
changing the model operator based on a second change algorithm changing an operator based on whether mathematical results of operations are matched, when an operator type of the model operator to be changed is determined as a second operator type indicating a simple operation having an operation difficulty below a predetermined level; and
changing the model operator based on a third change algorithm changing an operator based on similarity of mathematical results of operations, when an operator type of the model operator to be changed is determined as a third operator type indicating a layer-related operation rather than the simple operation.

15. The method of claim 11, wherein the changing the artificial intelligence-based model to the target model which is executable at the target device, based on the result of the comparison further comprises,
determining whether to change the model operator by comparing a user threshold included in a user input with similarity between the model operator and the replacement operator.

16. The method of claim 11, wherein the changing the artificial intelligence-based model to the target model which is executable at the target device, based on the result of the comparison further comprises,
determining whether to change the model operator based on whether the replacement operator is included in the target operator list.

17. The method of claim 1, further comprising:
providing a first result indicating a replacement operator to which the change is made in the changed target model, and a second result indicating whether the changed target model is required for retraining.

18. The method of claim 1, further comprising:
providing a benchmark result obtained by executing the target model to which the artificial intelligence-based model is changed, at the target device.

19. A non-transitory computer readable medium storing a computer program, wherein the computer program allows a computing device to perform following operations to change an artificial intelligence-based model to suit a target device based on a device awareness when executed by the computing device, and wherein the operations comprise:
obtaining model information corresponding to the artificial intelligence-based model, and target device information indicating a characteristic of the target device on which the artificial intelligence-based model is executed;
obtaining a model operator list comprising model operators by determining the model operators included in the artificial intelligence-based model based on the model information, and obtaining a target operator list comprising target operators by determining the target operators which are criteria for changing the model operators, based on the target device information;
comparing the model operator list and the target operator list; and
changing the artificial intelligence-based model to a target model which is executable at the target device, based on a result of the comparison.

20. A computing device for providing a benchmark result, comprising:
at least one processor; and
a memory,
wherein the at least one processor:
obtains model information corresponding to the artificial intelligence-based model, and target device information indicating a characteristic of the target device on which the artificial intelligence-based model is executed;
obtains a model operator list comprising model operators by determining the model operators included in the artificial intelligence-based model based on the model information, and obtaining a target operator list comprising target operators by determining the target operators which are criteria for changing the model operators, based on the target device information;
compares the model operator list and the target operator list; and
changes the artificial intelligence-based model to a target model which is executable at the target device, based on a result of the comparison.
